(19) United States
(12) Patent Application Publication
(10) Pub. No.: US 2016/0323603 A1
(43) Pub. Date: Nov. 3, 2016

(54) METHOD AND APPARATUS FOR PERFORMING AN ARITHMETIC CODING FOR DATA SYMBOLS

(71) Applicant: LG ELECTRONICS INC., Seoul (KR)

(72) Inventor: Amir SAID, Cupertino, CA (US)

(21) Appl. No.: 15/108,724

(22) PCT Filed: Jan. 2, 2015
(86) PCT No.: PCT/KR2015/000024

§ 371 Date: Jun. 28, 2016

Related U.S. Application Data
(60) Provisional application No. 61/922,857, filed on Jan. 1, 2014.

(51) Int. Cl. H04N 19/91; H04N 19/42

(52) U.S. Cl. CPC H04N 19/91; H04N 19/42

(57) ABSTRACT

Disclosed herein is a method of performing an arithmetic coding for data symbols, comprising: creating an interval for each of the data symbols, the interval being represented based on a starting point and a length of the interval; updating the interval for each of the data symbols using a multiplication approximation; and calculating the multiplication approximation of products using bit-shifts and additions within the updated interval.

### TECHNICAL FIELD

The present invention relates to a method and apparatus for processing a video signal and, more particularly, to a technology for performing an arithmetic coding for data symbols.

### BACKGROUND ART

Entropy coding is the process used to optimally define the number of bits that go into a compressed data sequence. Thus, it is a fundamental component of any type of data and media compression, and strongly influences the final compression efficiency and computational complexity. Arithmetic coding is an optimal entropy coding technique, with relatively high complexity, but that has been recently widely adopted, and is part of the H.264/AVC, H.265/HEVC, VP8, and VP9 video coding standards. However, increasing demands for very-high compressed-data-throughput, by applications like UHD and high-frame-rate video, require new forms of faster entropy coding.

### DISCLOSURE

### Technical Problem

There is problem in that binarization forces the sequential decomposition of all data to be coded, so it can only be made faster by higher clock speeds.

There is problem in that narrow registers require extracting individual data bits as soon as possible to avoid losing precision, which is also a form of unavoidable serialization.

There is problem in that complicated product approximations were defined in serial form, while fast multiplications are fairly inexpensive.

There is problem in that when the alphabet size increases, higher precision for the products is required but consequently the efficiency on general-purpose processors decreases.

There is problem in that the information about a symbol is defined not directly in terms of bits, but as a ratio between elements Dk and Lk, in an arithmetic coding.

### Technical Solution

An embodiment of the present invention provides a method of increasing the throughput of the arithmetic coding by using larger data alphabets and long registers for computation, and also by replacing the multiplications and divisions by approximations.

Furthermore, an embodiment of the present invention proposes an arithmetic coding system designed to work directly with large data alphabets, using wide processor registers, and generating compressed data in binary words.

Furthermore, an embodiment of the present invention proposes a method of enabling much more efficient renormalization operations and the precision required for coding with large alphabets by using long registers for additions.

Furthermore, an embodiment of the present invention proposes sets of operations required for updating arithmetic coding interval data.

Furthermore, an embodiment of the present invention proposes how to define a special subset of bits to be extracted from both Dₖ and Lₖ to create a table index.

### Advantageous Effects

In accordance with the present invention, the throughput (bits processed per second) of the arithmetic coding can be increased, by using larger data alphabets and long registers for computation, and also by replacing the multiplications and divisions by approximations.

Furthermore, in accordance with the present invention, to use long registers for additions allows much more efficient renormalization operations and the precision required for coding with large alphabets.

Furthermore, in accordance with the present invention, larger tables will allow great reductions in the search intervals.

### DESCRIPTION OF DRAWINGS

FIGS. 1 and 2 illustrate schematic block diagrams of an encoder and decoder which process a video signal in accordance with embodiments to which the present invention is applied.

FIG. 3 is a flowchart illustrating sets of operations required for updating arithmetic coding interval data.

FIGS. 4 and 5 illustrate schematic block diagrams of an encoder and decoder which process a video signal based on binary arithmetic coding in accordance with embodiments to which the present invention is applied.

FIGS. 6 and 7 illustrate schematic block diagrams of an encoder and decoder of an arithmetic coding system designed by using large data alphabets and long registers in accordance with embodiments to which the present invention is applied.

FIG. 8 shows a diagram with the binary representation of Lₖ, and the position of most important bits in accordance with an embodiment to which the present invention is applied.

FIG. 9 shows a diagram with the binary representation of Dₖ and Lₖ on P-bit registers in accordance with an embodiment to which the present invention is applied.

FIG. 10 is a flowchart illustrating a method of performing an arithmetic coding for data symbols in accordance with an embodiment to which the present invention is applied.

FIG. 11 is a flowchart illustrating a method of decoding data symbols in accordance with an embodiment to which the present invention is applied.

FIG. 12 is a flowchart illustrating a method of creating indexes for a decoding table in accordance with an embodiment to which the present invention is applied.

### BEST MODE

In accordance with an aspect of the present invention, there is provided a method of performing an arithmetic coding for data symbols, comprising: creating an interval for each of the data symbols, the interval being represented based on a starting point and a length of the interval; updating the interval for each of the data symbols using a multiplication approximation; and calculating the multiplication approximation of products using bit-shifts and additions within the updated interval.

The multiplication approximation of the products is performed by using optimization of factors including negative numbers.

The multiplication approximation of the products is scaled with the number of register bits.

In an aspect of the present invention, the method further includes determining a position of most significant 1 bit of the length; and extracting some of most significant bits of the length after the most significant 1 bit, to obtain the approximated length, wherein the interval is updated based on the approximated length and resulting bits of the products.

In accordance with another aspect of the present invention, there is provided a method of decoding data symbols, comprising: receiving location information of code value; checking a symbol corresponding to the location information of code value; and decoding the checked symbol, wherein the code value has been calculated by a multiplication approximation using bit-shifts and additions.

In an aspect of the present invention, the decoding method further includes determining a position of most significant 1 bit of an interval length; extracting most significant bit of the interval length after the most significant 1 bit by starting from the position plus 1 bit; extracting most significant bit of the code value by starting from the position; and generating a decoding table index by combining the most significant bit of the interval length and the most significant bit of the code value.

In accordance with another aspect of the present invention, there is provided an apparatus of performing an arithmetic coding for data symbols, comprising: an entropy encoding unit configured to create an interval for each of the data symbols, the interval being represented based on a starting point and a length of the interval, update the interval for each of the data symbols using a multiplication approximation, and calculate the multiplication approximation of products using bit-shifts and additions within the updated interval.

The entropy encoding unit is further configured to determine a position of most significant 1 bit of the length, and extract some of most significant bits of the length after the most significant 1 bit, to obtain the approximated length, wherein the interval is updated based on the approximated length and resulting bits of the products.

In accordance with another aspect of the present invention, there is provided an apparatus of decoding data symbols, comprising: an entropy decoding unit configured to receive location information of code value, check a symbol corresponding to the location information of code value, and decode the checked symbol, wherein the code value has been calculated by a multiplication approximation using bit-shifts and additions.

The entropy decoding unit is further configured to determine a position of most significant 1 bit of an interval length, extract most significant bit of the interval length after the most significant 1 bit by starting from the position plus 1 bit, extract most significant bit of the code value by starting from the position, and generate a decoding table index by combining the most significant bit of the interval length and the most significant bit of the code value.

### MODE FOR INVENTION

Hereinafter, exemplary elements and operations in accordance with embodiments of the present invention are described with reference to the accompanying drawings. It is however to be noted that the elements and operations of the present invention described with reference to the drawings are provided as only embodiments and the technical spirit and kernel configuration and operation of the present invention are not limited thereto.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process.

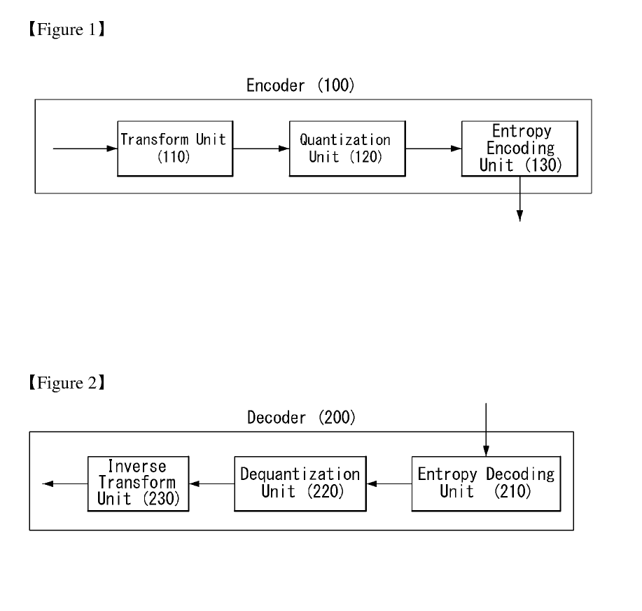

FIGS. 1 and 2 illustrate schematic block diagrams of an encoder and decoder which process a video signal in accordance with embodiments to which the present invention is applied.

The encoder 100 of FIG. 1 includes a transform unit 110, a quantization unit 120, and an entropy encoding unit 130. The decoder 200 of FIG. 2 includes an entropy decoding unit 210, a dequantization unit 220, and an inverse transform unit 230.

The encoder 100 receives a video signal and generates a prediction error by subtracting a predicted signal from the video signal.

The generated prediction error is transmitted to the transform unit 110. The transform unit 110 generates a transform coefficient by applying a transform scheme to the prediction error.

The quantization unit 120 quantizes the generated transform coefficient and sends the quantized coefficient to the entropy encoding unit 130.

The entropy encoding unit 130 performs entropy coding on the quantized signal and outputs an entropy-coded signal. In this case, the entropy coding is the process used to optimally define the number of bits that go into a compressed data sequence. Arithmetic coding, which is one of an optimal entropy coding technique, is a method of representing multiple symbols by a single real number.

The present invention defines improvements on methods to increase the throughput (bits processed per second) of the arithmetic coding technique, by using larger data alphabets (many symbols, instead of only the binary alphabet) and longer registers for computation (e.g., from 8 or 16 bits to 32, 64, or 128 bits), and also by replacing the multiplications and divisions by approximations.

In an aspect of the present invention, the entropy encoding unit 130 may update the interval for each of the data symbols using a multiplication approximation, and calculate the multiplication approximation of products using bit-shifts and additions within the updated interval.

In the process of the calculating, the entropy encoding unit 130 may determine a position of most significant 1 bit of the length, and extract some of most significant bits of the length after the most significant 1 bit, to obtain the approximated length. In this case, the interval is updated based on the approximated length and resulting bits of the products.

The decoder 200 of FIG. 2 receives a signal output by the encoder 100 of FIG. 1.

The entropy decoding unit 210 performs entropy decoding on the received signal. For example, the entropy decoding unit 210 may receive a signal including location information of code value, check a symbol corresponding to the location information of code value, and decode the checked symbol. In this case, the code value has been calculated by a multiplication approximation using bit-shifts and additions.

In another aspect of the present invention, the entropy decoding unit 210 may generate a decoding table index by combining the most significant bit of the interval length and the most significant bit of the code value.

In this case, the most significant bit of the interval length can be extracted after the most significant 1 bit by starting from the position plus 1 bit, and the most significant bit of the code value can be extracted by starting from a position of most significant 1 bit of an interval length.

Meanwhile, the dequantization unit 220 obtains a transform coefficient from the entropy-decoded signal based on information about a quantization step size.

The inverse transform unit 230 obtains a prediction error by performing inverse transform on the transform coefficient. A reconstructed signal is generated by adding the obtained prediction error to a prediction signal.

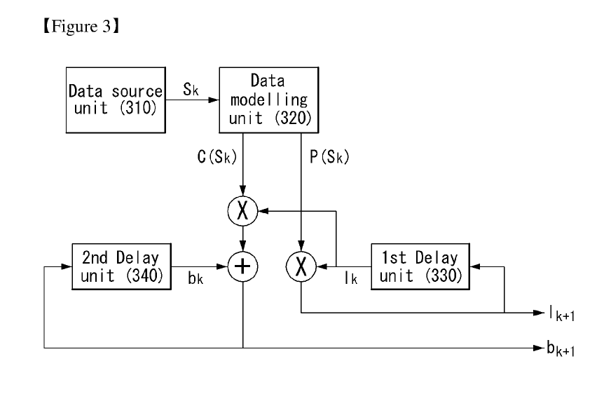

FIG. 3 is a flowchart illustrating sets of operations required for updating arithmetic coding interval data.

The arithmetic coder to which the present invention is applied can include data source unit(310), data modelling unit(320), 1^{st} delay unit(330) and 2^{nd} delay unit.

The data source unit(310) can generate a sequence of N random symbols, each from an alphabet of M symbols, as the following equation 1.

S={s₁,s₂,s₃, . . . ,s_{N}},sₖε{0,1,2, . . . ,M−1} [Equation 1]

In this case, the present invention assumes that the data symbols are all independent and identically distributed (i.i.d.), with nonzero probabilities as the following equation 2.

Prob{sₖ=n}=p(n)>0,k=1,2, . . . ,N,n0,1, . . . ,M−1 [Equation 2]

And, the present invention can define the cumulative probability distribution, as the following equation 3.

$$c ( n ) = {\sum }_{s = 0}^{n - 1} p ( s ) , \\ n = 0 , 1 , … , M \qquad [ Equation 3 ]$$

In this case, c(s) is strictly monotonic, and c(0)=0 and c(M)=1.

Even though those conditions may seem far different from what is found in actual complex media signals, in reality all entropy coding tools are based on techniques derived from those assumptions, so the present invention can provide embodiments constrained to this simpler model.

Arithmetic coding consists mainly of updating semi-open intervals in the line of real numbers, in the form [bₖ, bₖ+lₖ), where bₖ represents the interval base and lₖ represents its length. The intervals may be updated according to each data symbol sₖ, and starting from initial conditions b1=0 and l1=1, they are recursively updated for k=1, 2, . . . , N using the following equations 4 and 5.

lₖ₊₁=p(sₖ)lₖ [Equation 4]

bₖ₊₁=bₖ+c(sₖ)lₖ [Equation 5]

In this case, the intervals may be progressively nested, as the following equation 6.

[bₖ,bₖ+lₖ) [symbol] [bᵢ,bᵢ+lᵢ),k=1,2, . . . ,i−1,i=2,3, . . . ,N+1 [Equation 6]

As described above, referring to FIG. 3, the data modelling unit(320) can receive a sequence of N random symbols Sₖ, and output the cumulative probability distribution C(Sₖ) and symbol probability p(Sₖ).

The interval length lₖ₊₁ can be obtained by multiplication operation of Sₖ outputted from the data modelling unit(320) and lₖ outputted from 1^{st} delay unit(330).

And, the interval base bk+1 can be obtained by addition operation of bk outputted from 2^{nd} delay unit(340) and the multiplication of C(Sₖ) and lₖ.

The arithmetic coding to which the present invention is applied can be defined by the arithmetic operations of multiplication and addition. In this case, bₖ and lₖ can be represented with infinite precision, but this is done to first introduce the notation in a version that is intuitively simple. Later the present invention provides methods for implementing arithmetic coding approximately using finite precision operations.

After the final interval [b_{N+1}, b_{N+1}+l_{N+1}) has been computed the arithmetic encoded message is defined by a code value \hat{V}ε[b_{N+1}, b_{N+1}+l_{N+1}). It can be proved that there is one such value that can be represented using at most 1+log 2(l_{N+1}) bits.

To decode the sequence S using code value \hat{V}, the present invention again starts from initial conditions b₁=0 and l₁=1, and then use the following equations 7 to 9 to progressively obtain sₖ, lₖ, and bₖ.

$$\begin{matrix}{s}_{k} = \{ s : c ( s ) \leq \frac{\hat{υ} - {b}_{k}}{{l}_{k}} < c ( s + 1 ) \} & [ Equation 7 ] \\ {l}_{k + 1} = p ( {s}_{k} ) {l}_{k} & [ Equation 8 ] \\ {b}_{k + 1} = {b}_{k} + c ( {s}_{k} ) {l}_{k} & [ Equation 9 ]\end{matrix}$$

The correctness of this decoding process can be concluded from the property that all intervals are nested, that \hat{V}ε[b_{N+1}, b_{N+1}+l_{N+1}), and assuming that the decoder perfectly reproduces the operations done by the encoder.

For a practical implementation of arithmetic coding, the present invention can consider that all additions are done with infinite precision, but multiplications are approximated using finite precision, in a way that preserves some properties. This specification will cover only the aspects needed for understanding this invention. For instance, interval renormalization is an essential part of practical methods, but it is not explained in this specification since it does not affect the present invention.

The present invention can use symbols Bₖ, Lₖ, and Dₖ to represent the finite precision values (normally scaled to integer values) of bₖ, lₖ and \hat{V}−bₖ, respectively. the aspects of encoding can be defined by the following equations 10 and 11.

Lₖ₊₁=[[c(sₖ+1)Lₖ]]−[[c(sₖ)Lₖ]] [Equation 10]

Bₖ₊₁=Bₖ+[[c(sₖ)Lₖ]] [Equation 11]

In this case, the double brackets surrounding the products represent that the multiplications are finite-precision approximations.

The equation 10 corresponds to equation 4 because p(s)=c(s+1)−c(s) (s=1, 2, . . . , M).

Thus, the decoding process can be defined by the following equations 12 to 14.

Sₖ={s:[[c(s)Lₖ]]≦Dₖ<[[c(s+1)Lₖ]]} [Equation 12]

Lₖ₊₁=[[c(sₖ+1)Lₖ]]−[[c(sₖ)Lₖ]] [Equation 13]

Bₖ₊₁=Bₖ+[[c(sₖ)Lₖ]] [Equation 14]

One important aspect of arithmetic decoding is that, except in some trivial cases, there are no direct method for finding sₖ in eq. (7), and some type of search is needed. For instance, since c(s) is strictly monotonic the present invention can use bisection search and find sk with O(log₂ M) tests. The average search performance can be also improved by using search techniques that exploit the distribution of symbol probabilities.

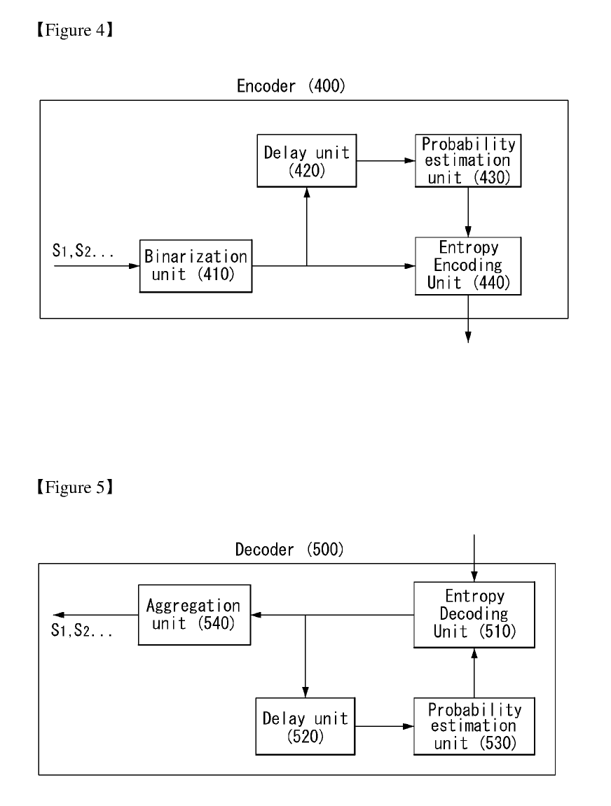

FIGS. 4 and 5 illustrate schematic block diagrams of an encoder and decoder which process a video signal based on binary arithmetic coding in accordance with embodiments to which the present invention is applied.

Implementers of arithmetic coding to which the present invention has been applied can deal with the following factors.

Firstly, arithmetic operations like multiplication were relatively very expensive, so they were replaced by even rough approximations, and table-look-up approaches.

Secondly, even with elimination of products, the present invention needs processor registers to keep the intermediate results and additions. For simpler hardware implementation there were techniques developed to work with registers of only 8 or 16 bits.

Thirdly, the decoder can be much slower than the encoder because it has to implement the search of the equation (12), and this complexity increases with alphabet size M.

One form of coding that first addressed all these problems was binary arithmetic coding, which is applied to only a binary input alphabet (i.e., M=2). This is not a fundamental practical constraint, since data symbols from any alphabet can be converted to sequences of binary symbols (binarization). FIGS. 4 and 5 show an encoder and a decoder that implements this type of coding respectively.

The encoder(400) includes binarization unit(410), delay unit(420), probability estimation unit(430) and entropy encoding unit(440). And, the decoder(500) includes entropy decoding unit(510), delay unit(520), probability estimation unit(530) and aggregation unit(540).

The binarization unit(410) can receive a sequence of data symbols and output bin string consisted of binarized values 0 or 1 by performing the binarization. The outputted bin string is tranmitted to probability estimation unit(430) through delay unit(420). The probability estimation unit(430) performs probability estimation for entropy-encoding.

The entropy encoding unit(440) entropy-encodes the outputted bin string and outputs compressed data bits.

The decoder(500) can perform the above encoding process reversely.

However, the coding system of FIGS. 4 and 5 can have the following problems.

Binarization forces the sequential decomposition of all data to be coded, so it can only be made faster by higher clock speeds.

Narrow registers require extracting individual data bits as soon as possible to avoid losing precision, which is also a form of unavoidable serialization.

Complicated product approximations were defined in serial form, while fast (exact) multiplications are fairly inexpensive.

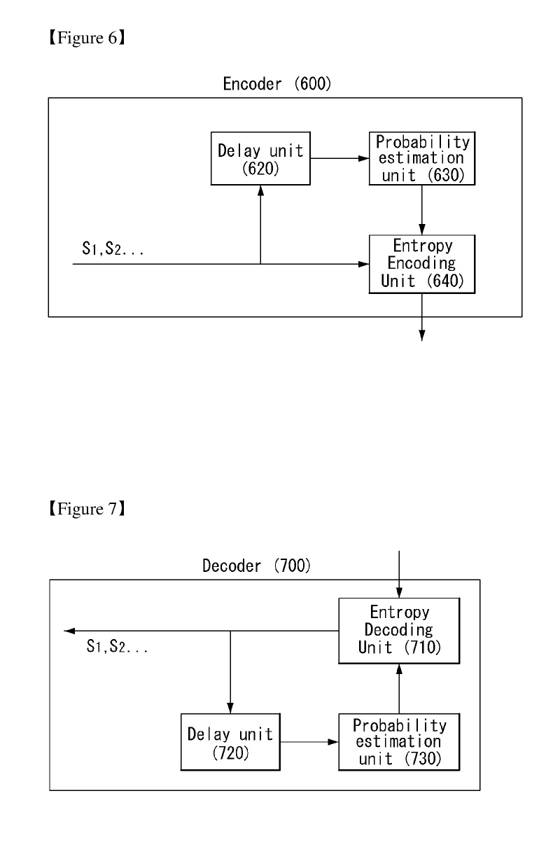

Thus, the present invention provides techniques that exploit new hardware properties, meant to increase the data throughput (bits processed per second) of arithmetic coding. They are applicable to any form of arithmetic coding, but are primarily designed for the system of FIGS. 6 and 7. The system of FIGS. 6 and 7 can have the following characteristics: ability to code using large data alphabets, wide processor registers (32, 64, 128 bits or more), and generating compressed data in multiple bytes (renormalization generates one, two, or more bytes).

The advantage of using long registers for additions is that it allows much more efficient renormalization operations, and the precision required for coding with large alphabets (and without using binarization). The present invention can assume that those long registers are used primarily only for additions and bit shifts, which can be easily supported with very low complexity in any modern process or custom hardware. As explained next, the present invention proposes doing approximations to multiplications with only bit-shifts and additions, or shorter multiplication registers.

FIGS. 6 and 7 illustrate schematic block diagrams of an encoder and decoder of an arithmetic coding system designed by using large data alphabets and long registers in accordance with embodiments to which the present invention is applied.

Referring to FIGS. 6 and 7, the encoder(600) includes delay unit(620), probability estimation unit(630) and entropy encoding unit(640). And, the decoder(700) includes entropy decoding unit(710), delay unit(720) and probability estimation unit(730). In this case, the entropy encoding unit(640) can directly receive large data alphabets, and generate compressed data in binary words based on large data alphabets and long register.

Furthermore, the explanation of FIGS. 4 and 5 can be similarly applied for the above functional units of the encoder(600) and the decoder(700).

As can be seen in equations (10), (11), (13), (14), and (15), one of the most important operations for arithmetic coding is computation of approximations of products in the form [[c(sₖ)Lₖ]], where c(sₖ)ε[0, 1] is a fraction, and Lₖ is an integer with P-bits.

Current processors can perform exact multiplications very efficiently, but the hard ware complexity of multiplications grows with O(P²), so it is still expensive for P larger than 16 on embedded processors and custom hardware. For example, if P which equals to 64, 128, or even more bits is considered, the present invention needs to provide an approximation that scales well with the number of register bits.

Assuming registers with P bits of precision, and given a fraction c which has been computed based on estimated symbol probabilities, the present invention can propose using the family of approximations in the following equation 15.

$$[ [ cL ] ] = {\sum }_{i = 1}^{F} ⌊ \frac{{X}_{i} L}{{2}^{{E}_{i}}} ⌋ , \\ {X}_{i} ∈ \{ 1 , - 1 \} , \\ i = 1 , 2 , … , F \qquad [ Equation 15 ]$$

In equation 15, Eᵢ are nonnegative integer constants, and Aᵢ and Eᵢ may be optimized for the specific value of c.

The present invention proposes that the division by powers of two may be implemented using bit shifts. Those are efficiently computed using barrel shifter hardware, which is common in all new processors (enabling bit shits in one clock cycle), and have hardware complexity defined by O(P log₂ P)

Furthermore, the equation 15 may be an operation with very low complexity by changing the sign, as the following equation 16.

$$[ [ cL ] ] = {\sum }_{i = 1}^{F} ⌊ \frac{{A}_{i} ⊗ L}{{2}^{{E}_{i}}} ⌋ , \\ {A}_{i} ∈ \{ 0 , {2}^{P} - 1 \} , \\ i = 1 , 2 , … , F . \qquad [ Equation 16 ]$$

In this case, the notation [symbol] represents the bitwise XOR operation.

Here, the extension is also similar to conventional approximations to multiplication, which are equivalent to using Xᵢε{0, 1}.

However, the present invention shows that the use of negative numbers and optimization of factors yield much better approximations for arithmetic coding, with a very small number of factors. For instance, with F=2 the worst-case relative compression redundancy for binary coding is reduced from 1% to less than 0.3%.

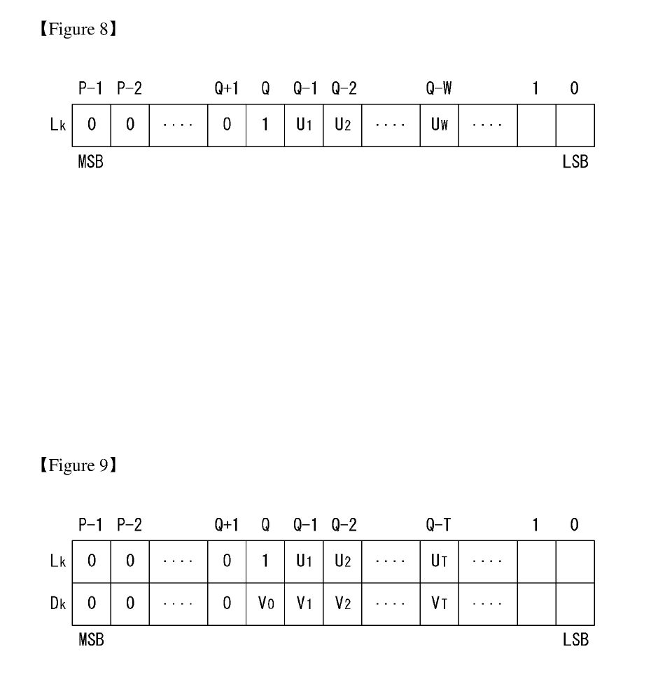

FIG. 8 shows a diagram with the binary representation of Lk, and the position of most important bits in accordance with an embodiment to which the present invention is applied.

In an aspect of the present invention, multiplication approximations using reduced precision products will be explained.

The present invention is efficient for custom hardware and, when F is small, for general-purpose processors. However, when the alphabet size increases, the system needs higher precision for the products [[cL]], and consequently higher values of F, decreasing the efficiency on general-purpose processors.

Thus, the present invention can use the fact that reduced-precision multiplications is already supported in all general-purpose processors, and the system to which the present invention is applied can be done efficiently in custom hardware to enable more accurate computations, and still use long registers for additions.

To avoid divisions, the present invention can have cumulative distributions as the following equation 17.

$$c ( s ) = ⌊ \frac{C ( s )}{{2}^{- Y}} ⌋ \qquad [ Equation 17 ]$$

In this case, C(s) represents positive integers using less than Y bits of precision. For example, C(s) may be defined as the following equation 18.

0≦C(s)<2^{Y}−1,s=1,2, . . . ,M+ [Equation 18]

Assuming P-registers for representing Bₖ and Lₖ, if the system can implement multiplications efficiently with H-bit registers, the present invention can use only the most significant bits of Lₖ for obtaining good approximations.

Referring to FIG. 8, it shows a diagram with the binary representation of Lₖ, and the position of most important bits. The condition for avoiding multiplication overflow may be defined as the following equation 19.

Y+W+1≦H [Equation 19]

Using as many bits as possible, the overall algorithm to compute multiplication approximations can be provided as the following process.

Firstly, the present invention can determine the bit position Q of the most significant 1-bit of Lₖ, and starting from bit position Q, extract the W+1=H−Y most significant bits of Lₖ to obtain \tilde{L}ₖ. Then, the present invention can use a H-bit register to compute C(s)×\tilde{L}ₖ, and for interval update use the following equation 20.

[[c(s)Lₖ]]=(C(s)×\hat{L}ₖ)2^{Q+1-H} [Equation 20]

The determination of Q can be done very efficiently in hardware, and is supported by assembler instructions in all important processor platforms. For instance, the assembler instructions can include the Bit Scan Reverse (BSR) instruction in the Intel, and Count Leading Zeros (CLZ) instruction in the ARM processors. Extracting bits and scaling by powers of two can also be done with inexpensive bit shifts.

FIG. 9 shows a diagram with the binary representation of Dₖ and Lₖ on P-bit registers in accordance with an embodiment to which the present invention is applied.

In an aspect of the present invention, table-based decoding method will be explained.

Another problem to be solved by the present invention is the complexity of finding sₖ using p(s)=c(s+1)−c(s). If the present invention uses bisection or another form of binary-tree search, the present invention still has the same problem of sequentially decomposing the decoding process into binary decisions, and cannot improve significantly over the speed of binary arithmetic coding.

One approach that has been used to greatly accelerate the decoding of Huffman codes is to use table look-up, i.e., instead of reading one bit and moving to a new code tree node a time, several bits are read and used to create an index to a pre-computed table, which indicates the decoded symbol, how many bits to discard, or if more bits need to be read to determine the decoded symbol. This can be easily done because Huffman codes generate an integer number of bits per coded symbol, so it is always easy to define the next set of bits to be read. However, those conditions are not valid for arithmetic coding.

The problem with arithmetic coding is that the information about a symbol is defined not directly in terms of bits, but as a ratio between elements Dₖ and Lₖ. The known solutions deal with this problem by using divisions to normalize Dₖ, but divisions can be prohibitively expensive, even for 32-bit registers.

Accordingly, the present invention provides a method to define a special subset of bits to be extracted from both Dₖ and Lₖ to create a table index, and having the table elements inform the range of symbols that needs to be further searched, not directly, but as worst case.

Hereinafter, it will be explained how this approach works by describing how to create the table indexes and entries.

The present invention can use the following equation 21 to conclude that even though the values of Dₖ and Lₖ can vary significantly, their ratios are defined mostly by the most significant nonzero bits of their representation.

0≦\hat{v}−bₖ<lₖ [symbol] 0<Dₖ<Lₖ [Equation 21]

Referring to FIG. 9, it shows the binary representation of Dₖ and Lₖ, stored as P bit integers. The present invention can use fast processor operations to identify the position Q of the most significant 1-bit of Lₖ. With that, the present invention extracts T bits u₁u₂ . . . u_{T} from Lₖ, and T+1 bits v₀v₁v₂ . . . v_{T} from Bₖ, as shown in FIG. 9. Those bits are used to create the integer Z, with binary representation u₁u₂ . . . u_{T}v₀v₁v₂ . . . u_{T}, which will be used as the index to a decoding table with 2^{2T+1} entries.

Given an index Z, upper and lower bounds of a normalized Lₖ can be derived from these bits, as the following equation 22.

$${L}_{min} ( Z ) = {2}^{P - 1} + {\sum }_{n = 1}^{T} {u}_{n} {2}^{P - 1 - n} , \\ {L}_{max} ( Z ) = {2}^{P - 1 - T} + {L}_{min} ( Z ) \qquad [ Equation 22 ]$$

Similarly, for a normalized DP the following equation 23 can be applied.

$${D}_{min} ( Z ) = {\sum }_{n = 0}^{T} {υ}_{n} {2}^{P - 1 - n} , \\ {D}_{max} ( Z ) = {2}^{P - 1 - T} + {D}_{min} ( Z ) \qquad [ Equation 23 ]$$

With those values and the cumulative distribution c, the present invention can pre-compute the table entries as the following equation 24.

sₘᵢₙ(Z)={s:[[c(s)Lₘₐₓ(Z)]]≦Dₘᵢₙ(Z)<[[c(s+1)Lₘₐₓ(Z)]]}

sₘₐₓ(Z)={s:[[c(s)Lₘᵢₙ(Z)]]≦Dₘₐₓ(Z)<[[c(s+1)Lₘᵢₙ(Z)]]} [Equation 24]

Accordingly, the present invention can provide the symbol decoding process, as follows.

The decoder can determine the bit position Q of the most significant 1-bit of Lₖ, and starting from bit position Q+1, extract the T most significant bits of Lₖ. And, starting from bit position Q, the decoder can extract the T+1 most significant bits of Bₖ.

Then, the decoder can combine the 2T+1 bits to form table index Z, and search only in the interval [sₘᵢₙ(Z), sₘₐₓ(Z)] the value of s that satisfies the following equation 25.

[[c(s)Lₖ]]≦Dₖ<[[c(s+1)Lₖ]] [Equation 25]

According to the above process, larger tables will allow great reductions in the search intervals, and for sufficiently large tables for most symbols the present invention will have sₘᵢₙ(Z)=sₘₐₓ(Z), meaning that they can be decoded without the need for additional tests.

Meanwhile, the values of sₘᵢₙ(Z) and sₘₐₓ(Z) need to be slightly modified to accommodate for effects of product approximations, but those can be easily computed when the actual approximation is known.

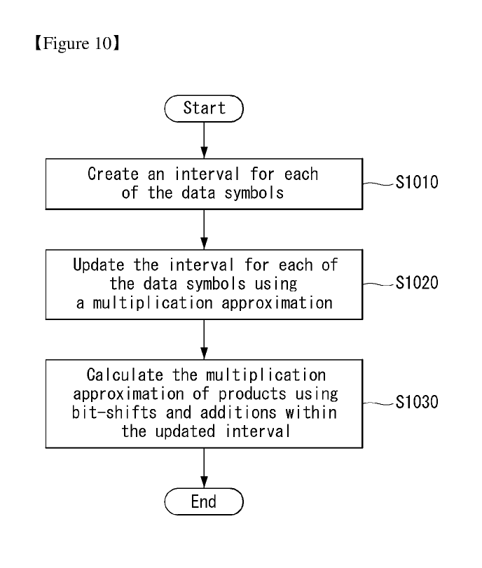

FIG. 10 is a flowchart illustrating a method of performing an arithmetic coding for data symbols in accordance with an embodiment to which the present invention is applied.

For an arithmetic coding for data symbols, firstly, an encoder can create an interval for each of the data symbols (S1010). In this case, the interval is represented based on a starting point and a length of the interval.

The encoder can update the interval for each of the data symbols using a multiplication approximation (S1020).

In this case, the multiplication approximation of the products can be performed by using optimization of factors including negative numbers.

Furthermore, the multiplication approximation of the products can be scaled with the number of register bits.

And then, the encoder can calculate the multiplication approximation of products using bit-shifts and additions within the updated interval (S1030).

In this case, the encoder can determine a position of most significant 1 bit of the length, and can extract some of most significant bits of the length after the most significant 1 bit, to obtain the approximated length.

The interval can be updated based on the approximated length and resulting bits of the products.

Through the above process, the bits processed per second of the arithmetic coding can be increased, by using larger data alphabets and long registers for computation.

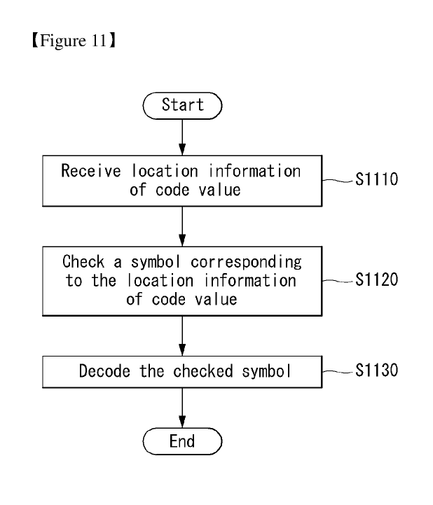

FIG. 11 is a flowchart illustrating a method of decoding data symbols in accordance with an embodiment to which the present invention is applied.

The decoder to which the present invention is applied can receive a bitstream including location information of code value (S1110). In this case, the code value has been calculated by a multiplication approximation using bit-shifts and additions.

And, the decoder can check a symbol corresponding to the location information of code value (S1120), and decode the checked symbol (S1130).

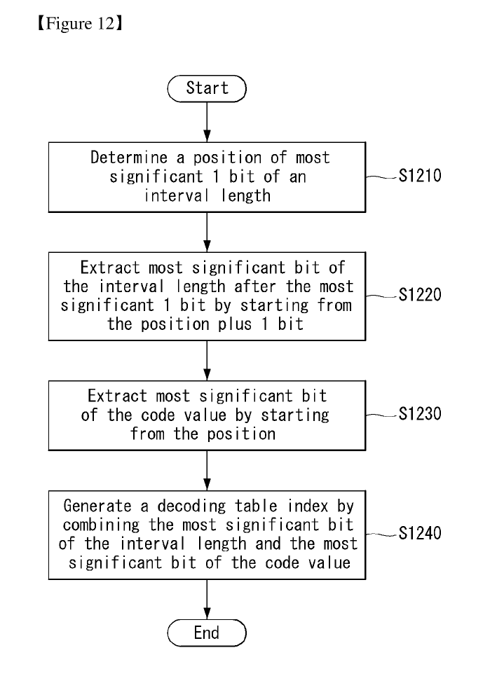

FIG. 12 is a flowchart illustrating a method of creating indexes for a decoding table in accordance with an embodiment to which the present invention is applied.

The decoder to which the present invention is applied can determine a position of most significant 1 bit of an interval length (S1210).

And, the decoder can extract most significant bit of the interval length after the most significant 1 bit by starting from the position plus 1 bit (S1220), and extract most significant bit of the code value by starting from the position (S1230).

And then, the decoder can generate a decoding table index by combining the most significant bit of the interval length and the most significant bit of the code value.

According to the above process, larger tables will allow great reductions in the search intervals.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional (3D) video apparatus, a teleconference video apparatus, and a medical video apparatus and may be used to process video signals and data signals.

Furthermore, the processing method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves (e.g., transmission through the Internet). Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of performing an arithmetic coding for data symbols, comprising:
creating an interval for each of the data symbols, the interval being represented based on a starting point and a length of the interval;
updating the interval for each of the data symbols using a multiplication approximation; and
calculating the multiplication approximation of products using bit-shifts and additions within the updated interval.

2. The method of claim 1,
wherein the multiplication approximation of the products is performed by using optimization of factors including negative numbers.

3. The method of claim 1,
wherein the multiplication approximation of the products is scaled with the number of register bits.

4. The method of claim 1, wherein the calculating step further comprises:
determining a position of most significant 1 bit of the length; and
extracting some of most significant bits of the length after the most significant 1 bit, to obtain the approximated length,
wherein the interval is updated based on the approximated length and resulting bits of the products.

5. A method of decoding data symbols, comprising:
receiving location information of code value;
checking a symbol corresponding to the location information of code value; and
decoding the checked symbol,
wherein the code value has been calculated by a multiplication approximation using bit-shifts and additions.

6. The method of claim 5, further comprising:
determining a position of most significant 1 bit of an interval length;
extracting most significant bit of the interval length after the most significant 1 bit by starting from the position plus 1 bit;
extracting most significant bit of the code value by starting from the position; and
generating a decoding table index by combining the most significant bit of the interval length and the most significant bit of the code value.

7. An apparatus of performing an arithmetic coding for data symbols, comprising:
an entropy encoding unit configured to
create an interval for each of the data symbols, the interval being represented based on a starting point and a length of the interval,
update the interval for each of the data symbols using a multiplication approximation, and
calculate the multiplication approximation of products using bit-shifts and additions within the updated interval.

8. The apparatus of claim 7,
wherein the multiplication approximation of the products is performed by using optimization of factors including negative numbers.

9. The apparatus of claim 7,
wherein the multiplication approximation of the products is scaled with the number of register bits.

10. The apparatus of claim 7, wherein the entropy encoding unit is further configured to:
determine a position of most significant 1 bit of the length, and
extract some of most significant bits of the length after the most significant 1 bit, to obtain the approximated length,
wherein the interval is updated based on the approximated length and resulting bits of the products.

11. An apparatus of decoding data symbols, comprising:
an entropy decoding unit configured to
receive location information of code value,
check a symbol corresponding to the location information of code value, and
decode the checked symbol,
wherein the code value has been calculated by a multiplication approximation using bit-shifts and additions.

12. The apparatus of claim 11, wherein the entropy decoding unit is further configured to:
determine a position of most significant 1 bit of an interval length,
extract most significant bit of the interval length after the most significant 1 bit by starting from the position plus 1 bit,
extract most significant bit of the code value by starting from the position, and
generate a decoding table index by combining the most significant bit of the interval length and the most significant bit of the code value.
